(19) United States
(12) Patent Application Publication
(10) Pub. No.: US 2026/0239004 A1
(43) Pub. Date: Aug. 13, 2026

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventor: Dexin LI, Dongguan (CN)

(73) Assignee: GUANGDONG OPPO MOBILE TELECOMMUNICATIONS CORP., LTD., Dongguan (CN)

(21) Appl. No.: 19/640,245

(22) Filed: Apr. 6, 2026

Related U.S. Application Data
(63) Continuation of application No. PCT/CN2023/137582, filed on Dec. 8, 2023.

(51) Int. Cl. H04W 12/06; H04L 41/16; H04W 48/14

(52) U.S. Cl. CPC H04W 12/06; H04L 41/16; H04W 48/14

(57) ABSTRACT

Provided are a wireless communication method and a communication device. The method includes: a first device sends first information to a second device, the first information being used for authorizing the second device to send a query request for a first model. According to the present application, the first device, by means of the first information, authorizes the second device to send a query request for the first model.

### CROSS-REFERENCE TO RELATED APPLICATIONS

This application is a continuation of International Application No. PCT/CN2023/137582, filed on Dec. 8, 2023, the disclosure of which is hereby incorporated by reference in its entirety.

### TECHNICAL FIELD

This application relates to the field of communication technologies, and more specifically, to a wireless communication method and a communication device.

### BACKGROUND

In a wireless communication system, an artificial intelligence/machine learning (AI/ML) model is widely used. Generally, the AI/ML model may be trained by some devices and then provided for use by other devices. However, providing models to other devices may pose a risk of exposure of the model. For example, some devices may steal models through a large quantity of malicious query models. Therefore, how to avoid stealing models when other devices use models is a problem to be solved.

### SUMMARY

This application provides a wireless communication method and a communication device. The following describes the aspects related to this application.

According to a first aspect, a wireless communication method is provided, including: transmitting, by a first device, first information to a second device, where the first information is used to authorize the second device to transmit a query request for a first model.

According to a second aspect, a wireless communication method is provided, including: receiving, by a second device, first information transmitted by a first device, where the first information is used to authorize the second device to transmit a query request for a first model.

According to a third aspect, a communication device is provided, where the communication device is a first device and includes: a communication module, configured to transmit first information to a second device, where the first information is used to authorize the second device to transmit a query request for a first model.

According to a fourth aspect, a communication device is provided, where the communication device is a second device and includes: a communication module, configured to receive first information transmitted by a first device, where the first information is used to authorize the second device to transmit a query request for a first model.

According to a fifth aspect, a communication device is provided, where the communication device is a first device, including a memory, a processor, and a transceiver, the memory is configured to store a program, the processor is configured to invoke a program in the memory, the transceiver is configured to transmit first information to a second device, and the first information is used to authorize the second device to transmit a query request for a first model.

According to a sixth aspect, a communication device is provided, where the communication device is a second device, including a memory, a processor, and a transceiver, the memory is configured to store a program, the processor is configured to invoke a program in the memory, the transceiver is configured to receive first information transmitted by a first device, and the first information is used to authorize the second device to transmit a query request for a first model.

According to a seventh aspect, an apparatus is provided, including a processor configured to invoke a program from a memory, to cause the apparatus to execute the method according to the first aspect or the second aspect.

According to an eighth aspect, a chip is provided, including a processor configured to invoke a program from a memory, to cause a device installed with the chip to execute the method according to the first aspect or the second aspect.

According to a ninth aspect, a computer readable storage medium is provided, where a program is stored thereon, and the program causes a computer to execute the method according to the first aspect or the second aspect.

According to a tenth aspect, a computer program product is provided, including a program, where the program causes a computer to perform the method according to the first aspect or the second aspect.

According to an eleventh aspect, a computer program is provided, where the computer program causes a computer to perform a method according to the first aspect or the second aspect.

### BRIEF DESCRIPTION OF DRAWINGS

FIG. 1 is a schematic structural diagram of a wireless communication system applicable to an embodiment of this application.

FIG. 2 is a schematic structural diagram of an artificial neural network.

FIG. 3 is an example diagram of a life cycle of an AI/ML model.

FIG. 4A to FIG. 4B are schematic flowcharts of a downlink beam scanning process.

FIG. 5 is a schematic flowchart of a positioning service based on an AI/ML model.

FIG. 6 is a schematic flowchart of a model obfuscation technology.

FIG. 7 is a schematic flowchart of a wireless communication method according to an embodiment of this application.

FIG. 8A to FIG. 8D are example diagrams of a bit structure of first information.

FIG. 9 is an example diagram of a wireless communication method according to an embodiment of this application.

FIG. 10 is a schematic flowchart of a wireless communication method according to another embodiment of this application.

FIG. 11 is a schematic flowchart of a wireless communication method according to another embodiment of this application.

FIG. 12 is a schematic flowchart of a wireless communication method according to another embodiment of this application.

FIG. 13 is a schematic flowchart of a wireless communication method according to another embodiment of this application.

FIG. 14 is a schematic structural diagram of a first device according to an embodiment of this application.

FIG. 15 is a schematic structural diagram of a second device according to an embodiment of this application.

FIG. 16 is a schematic structural diagram of a communication apparatus according to an embodiment of this application.

### DESCRIPTION OF EMBODIMENTS

Technical solutions in this application are described below with reference to the accompanying drawings.

### Communication System Architecture

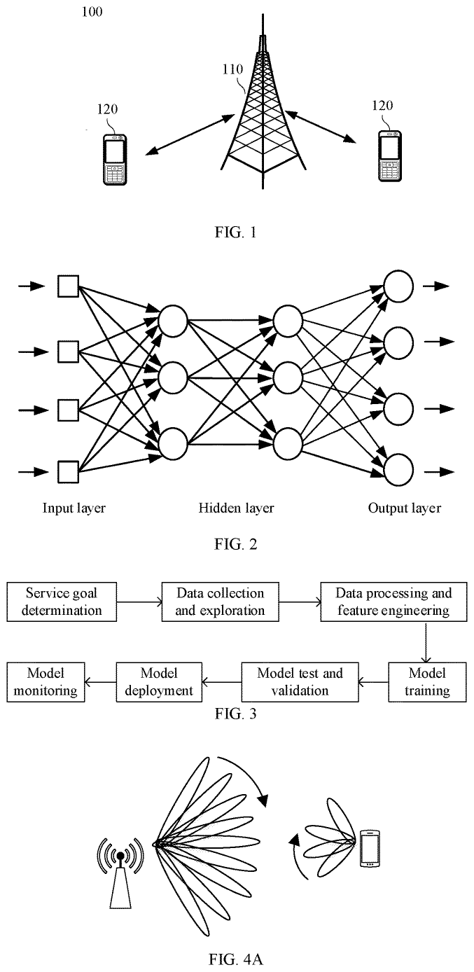

FIG. 1 is an example of a system architecture of a wireless communication system 100 that may be applied to an embodiment of this application. The wireless communication system 100 may include a network device 110 and a terminal device 120. The network device 110 may be a device that communicates with the terminal device 120. The network device 110 may provide communication coverage for a specific geographical area, and may communicate with the terminal device 120 located in the coverage area.

FIG. 1 shows one network device and one terminal device as an example. In at least one embodiment, the wireless communication system 100 may include one or more network devices 110, and/or one or more terminal devices 120. For a network device 110, the one or more terminal devices 120 may be located within network coverage of the network device 110, or may be located outside network coverage of the network device 110, or may be located partially within the network coverage of the network device 110, and may be located partially outside the network coverage of the network device 110, which is not limited in embodiments of this application.

In at least one embodiment, the wireless communication system 100 may further include another network entity such as a network controller or a mobility management entity, which is not limited in embodiments of this application.

It should be understood that the technical solutions in the embodiments of this application may be applied to various communication systems, for example, a 5th generation (5G) system or a new radio (NR) system, a long term evolution (LTE) system, an LTE frequency division duplex (FDD) system, and an LTE time division duplex (TDD) system. The technical solutions provided in this application may further be applied to a future communication system, such as a 6th generation mobile communication system or a satellite communication system. The terminal device in embodiments of this application may also be referred to as user equipment (UE), an access terminal, a subscriber unit, a subscriber station, a mobile site, a mobile station (MS), a mobile terminal (MT), a remote station, a remote terminal, a mobile device, a user terminal, a terminal, a wireless communication device, a user agent, or a user apparatus. The terminal device in embodiments of this application may be a device providing a user with voice and/or data connectivity and capable of connecting people, objects, and machines, such as a handheld device or a vehicle-mounted device having a wireless connection function. The terminal device in embodiments of this application may be a mobile phone, a tablet computer (Pad), a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. In at least one embodiment, a UE may be used to act as a base station. For example, a UE may act as a scheduling entity that provides sidelink signals between UEs in vehicle-to-everything (V2X) or device-to-device (D2D). For instance, a cellular phone and a vehicle communicate with each other using sidelink signals. A cellular phone and a smart home device communicate with each other, without relaying communication signals through a base station.

The network device in embodiments of this application may be a device configured to communicate with the terminal device. The network device may also be referred to as an access network device or a radio access network device. For example, the network device may be a base station. The network device in embodiments of this application may be a radio access network (RAN) node (or device) that connects the terminal device to a wireless network. The base station may broadly cover various names in or replace with the following names, such as a NodeB, an evolved NodeB (eNB), a next generation NodeB (gNB), a relay station, an access point, a transmitting and receiving point (TRP), a transmitting point (TP), a master station MeNB, a secondary station SeNB, a multimode radio (MSR) node, a home base station, a network controller, an access node, a wireless node, an access point (AP), a transmission node, a transceiver node, a base band unit (BBU), a remote radio unit (RRU), an active antenna unit (AAU), a remote radio head (RRH), a central unit (CU), a distributed unit (DU), and a positioning node DU. The base station may be a macro base station, a micro base station, a relay node, a donor node, or the like, or a combination thereof. Alternatively, the base station may be a communication module, a modem, or a chip disposed in the device or apparatus described above. Alternatively, the base station may be a mobile switching center, a device that functions as a base station in device-to-device D2D, V2X, or machine-to-machine (M2M) communication, a network-side device in a 6G network, a device that functions as a base station in a future communication system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to act as a mobile base station, and one or more cells may move based on a position of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

The network device and the terminal device may be deployed on land, including being deployed indoors or outdoors, handheld, or vehicle-mounted, may be deployed on a water surface, or may be deployed on a plane, a balloon, or a satellite in the air. In embodiments of this application, a scenario in which the network device and the terminal device are located is not limited.

### AI/ML Model

In recent years, artificial intelligence research represented by a neural network (NN) has achieved great achievements in many fields. In particular, as an important research direction of the AI technology, the AI/ML model successfully solves a series of difficult-to-handle problems by using a non-linear processing capability of the NN, and even performs stronger than human performance in fields such as image recognition, voice processing, natural language processing, and games. Therefore, more and more attention is paid to the AI/ML model recently. In addition, the AI/ML model also provides a new idea for solving a problem in the communication field. Previous research shows that the AI/ML model has important application potentials in complex and unknown environment modeling, learning, channel prediction, intelligent signal generation and processing, network status tracking and intelligent scheduling, and network optimization deployment. Therefore, the AI/ML model is expected to promote future evolution of communication paradigm and network architecture, which is of great significance and value to the research of communication technology.

Artificial neural network is a common AI/ML model. The artificial neural network may create a model according to training data, thereby making more accurate prediction. As shown in FIG. 2, an artificial neural network generally uses multi-layer designs. Feature learning is performed by means of layer-by-layer training of a multi-layer neural network, which can greatly improve a learning and processing capability of the neural network. Therefore, the artificial neural network is widely used in pattern recognition, signal processing, optimization combination, anomaly detection, and the like.

The AI/ML model lifecycle may be shown in FIG. 3, and mainly includes seven phases. The first phase is service goal determination phase, that is, the problem to be solved by the model. The second stage is the data collection and exploration stage. The relevant data can be collected for the training of the model according to the service objective. The third phase is a data processing and feature engineering phase. This phase includes data cleaning, data splitting into training sets, verification sets and test sets, and feature engineering processes for converting data. The fourth phase is the model training phase, which can test different models and training data sets, select appropriate models, and fine-tune their super parameters to achieve optimal performance. The fifth phase is the model test and validation phase, and the model can be checked against different evaluation indicators (e.g. accuracy) to ensure that its predictive performance is sufficient to meet the use cases. The sixth phase is the model deployment phase, where selected and fine-tuned models are deployed for prediction. The deployment type of the model may include online deployment, bulk deployment, and embedded deployment. The seventh phase is the model monitoring phase, that is, the performance of the model is monitored after deployment to ensure that it performs well over time.

### Application of AI/ML Model

Beam management is one of the typical application scenarios of the AI/ML model in the NR system (AI beam management). The AI/ML model helps reduce overhead and delay in the beam management process. Beam management may be divided into uplink and downlink beam management. The following row of beam management is used as an example to briefly describe a beam management mechanism.

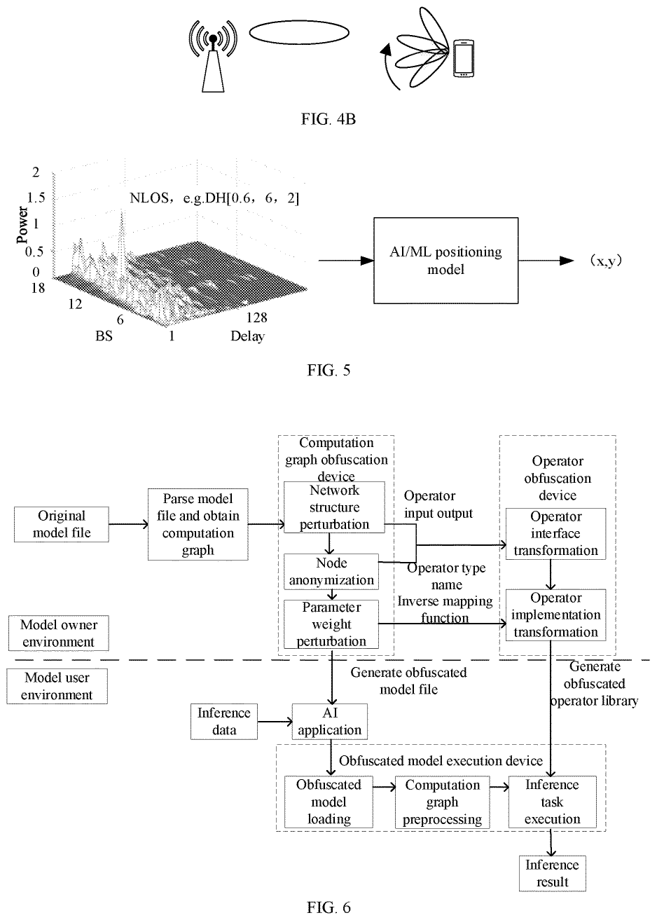

Downlink beam management may include processes such as downlink beam scanning, UE optimal beam reporting, and network (NW) indication of a downlink beam. The downlink beam scanning process can be illustrated as shown in FIG. 4. In FIG. 4A, the NW scans different transmit beam directions by using a synchronization signal and a synchronization signal and physical broadcast channel block (SSB) and/or a channel state information reference signal (CSI-RS) in the downlink reference signal. In FIG. 4B, the UE may measure using different receive beams, so that all beam pair combinations may be traversed, and a layer 1 reference signal received power (L1-RSRP) value of the UE may be calculated. In an optimal beam reporting process of the UE, the UE selects K transmit beams with a highest L1-RSRP by comparing L1-RSRP values of all beam pairs measured, and then reports the K transmit beams as uplink control information to the NW. Herein L1-RSRP may also be replaced with another beam link indicator, such as a layer 1 signal to interference noise ratio (L1-SINR) or layer 1 reference signal received quality (L1-RSRQ). After decoding the beam report of the UE, the NW may carry a transmission configuration indicator (TCI) status (including a transmit beam used as a reference by the SSB or the CSI-RS) by using medium access control (MAC) or downlink control information (DCI) signaling, so as to complete beam indication for the UE. Based on an indication of the NW, the UE performs receiving by using a receive beam corresponding to the transmit beam.

In the foregoing beam management, optimal beam prediction may be performed by using the AI/ML model, so as to reduce overhead and delay. The AI/ML model may be used for spatial beam prediction and time domain beam prediction. Specifically, the AI/ML model may implement beam prediction on the beam set A by using a measurement result of the beam set B. The set B may be a subset of the set A, and the set B and the set A may also be different beam sets (for example, the set A uses a narrow beam and the set B uses a wide beam). A measurement result on the set B may be L1-RSRP, or other auxiliary information, such as beam (pair) identity (ID). When beam prediction is performed, the AI/ML model may be deployed on an NW side, or may be deployed on a UE side.

In addition, positioning is also a typical application scenario (AI positioning) of the AI/ML model in the NR system. Higher precision positioning can be implemented based on the AI/ML model. Currently, the consumer market, such as shopping mall navigation, reverse car-finding in parking lots, family member tracking to prevent separation, and self-guided exhibition hall tours, as well as vertical industries, such as human flow monitoring and analysis, intelligent warehousing and logistics, smart manufacturing, emergency rescue, personnel asset management, and service robots, all demand for higher precision positioning services. In particular, for a complex environment such as a non line of sight (NLOS) scenario, high-precision positioning is a great challenge. However, the AI/ML model provides a new idea for high-precision positioning problems in complex environments such as NLOS.

The AI/ML model may be applied to positioning calculation to improve positioning accuracy and efficiency. For example, as shown in FIG. 5, a user may feed back channel measurement information from a base station to a user to a positioning server, and the positioning server may use the channel measurement information as input of an AI/ML positioning model, so as to obtain specific location coordinates of the user. It should be noted that the AI/ML model used for positioning may also be deployed on the UE side, which does not significantly affect the algorithm of the model.

### Security of the AI/ML Model

The AI/ML model provides great convenience for the communication system. However, when the AI/ML model is applied, a certain security challenge exists. A security issue of a typical AI/ML system may include security of software and hardware, data integrity, model confidentiality, model robustness, and data privacy. The security of software and hardware means that there may be some vulnerabilities in the AI/ML system at the software and hardware levels. The attacker may exploit these vulnerabilities to attack the system. Data integrity means that at the data level, an attacker can incorporate malicious data or noise in the training phase, affecting the inference capability of the AI/ML model. Data confidentiality refers to a model that is used on a model level. The model provider often wants to provide only model query services, but does not expose training models. However, through multiple queries, an attacker can construct a similar model, thereby obtaining relevant information of the model. Model robustness refers to that if the sample coverage of the training model is insufficient, the model robustness is not strong, and therefore, a correct judgment result cannot be given when a malicious sample is faced. Data privacy refers to a scenario in which a user provides training data, and an attacker can obtain privacy information of the user by repeatedly querying a trained model.

A main source of the foregoing security issues is a specific attack on the AI/ML system, such as adversarial example attack, data poisoning, model theft (model extraction), and artificial intelligence attack. The adversarial example attack is to add subtle, usually unrecognized interference to the input sample of the model, resulting in the model giving an incorrect output with high confidence. Data poisoning refers to adding carefully crafted anomalous data to the model training data, destroying the probability distribution of the original training data, resulting in classification or clustering errors in some conditions. Model theft (model extraction) refers to transmitting inference requests to a target model to perform a large quantity of queries and training another model with the same or similar functionality using the received response. Alternatively, a similar model is constructed by using a reverse attack technology, and a parameter inside the model is obtained, or a replacement model similar to a target model is constructed. An AI attack is a typical attack on a machine learning system, and is an attack that affects data confidentiality and data and calculation integrity. Other forms of attack may lead to denial of service, information disclosure, or invalid calculation.

For the foregoing security challenges, certain security protection measures may be used to protect the AI/ML model. The security protection of the AI/ML model can be divided into static protection and dynamic protection. Static protection refers to the protection of the model during transmission and storage. Currently, the model protection scheme based on file encryption is widely used in the industry. The AI/ML model file is transmitted and stored in ciphertext, and decrypted in memory before inference is executed. When static protection is used, the model remains in plaintext in the memory during the inference process, and there is a risk of being dumped from the memory by adversaries. Dynamic protection refers to the protection of the model during running, that is, the model is protected during the inference process. There are mainly three technical routes for dynamic protection, which are respectively a model protection solution based on a trusted execution environment (TEE), a protection solution based on encrypted computing, and a model protection solution based on obfuscation.

The TEE generally refers to a “security zone” isolated by using trusted hardware. The AI model file is encrypted for storage and transmission in the non-security zone, and runs in the security zone. In this solution, a inference delay on a central processing unit (CPU) is relatively low, but depends on specific trusted hardware, which is difficult to deploy. In addition, constrained by hardware resources, it is difficult to protect a large-scale deep model, and currently, heterogeneous hardware acceleration cannot be effectively supported. The protection solution based on the encrypted computing rely on the cryptographic method (such as homomorphic encryption and multi-party security calculation), so as to ensure that the model keeps the ciphertext state during transmission, storage, and running. This solution does not rely on specific hardware, but faces very large computational or communication overhead problems and cannot protect the model structure information. The obfuscated model protection solution has relatively low performance overhead and minimal accuracy loss, does not rely on specific hardware, and can support the protection of large models. The obfuscated model protection solution mainly scrambles the computing logic of the model, so that the adversary cannot understand the model even if the model can be obtained. A typical model obfuscation technology may be shown in FIG. 6. The technology may automatically obfuscate calculation logic of a plaintext AI/ML model, so that an attacker cannot understand the model even if the model is acquired during transmission and storage. In addition, the model can be executed in an obfuscated state to ensure confidentiality of the model when running. At the same time, the original inference result of the model is not affected, and only minimal inference performance overhead is required.

In the foregoing security challenges, the confidentiality of the model is one of the current concerns. The design and training of the AI/ML model require a large amount of time, data and power. Therefore, it is crucial to protect the model's intellectual property rights (including model structure and parameters) and prevent the model from being stolen during the running and deployment. The foregoing security protection measures may prevent a model from being stolen at a running, transmission, and storage stage to a certain extent. However, it cannot prevent model users from stealing the model by using a large quantity of malicious queries.

Model monitoring in the AI/ML model lifecycle may detect malicious queries in model theft to some extent. However, a time granularity of model monitoring is relatively small, and long-term monitoring requires greater resource overhead, which is difficult to support for a communication system. Therefore, model monitoring is generally difficult to realize real-time model performance awareness, and therefore, malicious query attacks cannot be detected in time. In addition, the model owner can also process only one query within a certain period of time to counter a large quantity of malicious queries. However, some models have a large input data dimension. When a model theft attack is encountered, even if the model owner does not process a corresponding query, a large quantity of input data is sent from a malicious attack device. These invalid data transmissions occupy a large quantity of air interface resource overhead. Therefore, how to effectively avoid model theft by model users through a large quantity of malicious queries is still a problem to be solved.

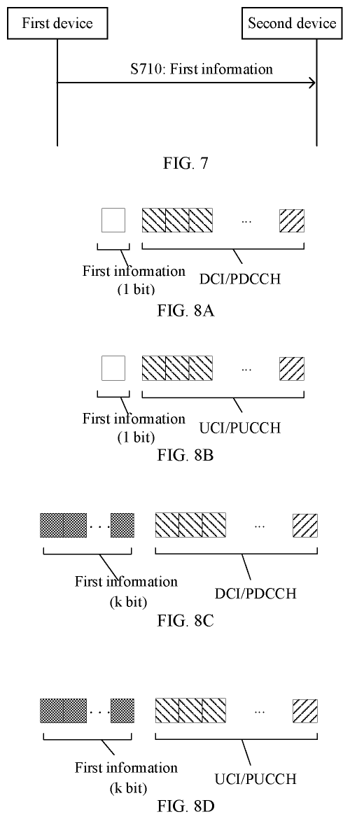

Based on this, the following describes in detail the wireless communication method provided in the embodiments of this application with reference to FIG. 7. For ease of understanding, the following uses a first device and a second device to represent devices that are applicable to the method. The first device may be an owner of the first model, for example, a terminal device or a network device that trains the first model. The second device may be a user of the first model, for example, a terminal device, a network device, or another device that has a query requirement on the first model. The terminal device and/or the network device herein may be any one of the foregoing terminal devices and/or network devices. Another device herein may be a device other than the terminal device and the network device that has a query requirement for the first model, for example, a server. A model type of the first model is not specifically limited, and the first model may be the foregoing AI/ML model. The first model may be configured to execute a service in a wireless communication system, such as a beam prediction service or a positioning service.

Referring to FIG. 7, in step S710, the first device transmits the first information to the second device. The first information may be used to authorize the second device to transmit a query request for the first model, and the query request herein may be one query for the first model. After receiving the first information, the second device may initiate a query request for the first model. The first model may be deployed on the first device, or the first model may be deployed on the second device. The query request of the second device for the first model may be initiated to the first device, or the query request of the second device for the first model may be initiated to the second device.

In this application, the first device authorizes, by using the first information, the second device to transmit a query request for the first model, which limits an opportunity for the second device to query the first model, and helps prevent the second device from stealing the first model by using a large quantity of malicious queries.

The following describes the first information in detail. The first information may include a quantity of times allowed to transmit query request and/or decryption information of the first model. The quantity of times allowed to transmit query request may be used to limit the quantity of times that the second device queries the first model, so as to prevent the second device from performing a large quantity of malicious queries on the first model in a short time for model theft. The decryption information of the first model may be key information used for model decryption, and the second device may decrypt the encrypted first model based on the decryption information, so as to perform model query.

Further, in a case in which the first model is deployed on the second device, the first information may include decryption information. As an example, the first device may deploy the first model in an encrypted manner on the second device, and the second device needs the decrypted information from the first device to query the first model. Based on this, query by the second device on the first model deployed locally may be limited, so as to help prevent the second device from stealing the first model deployed locally on the second device. The encryption manner of the first model may be the foregoing static protection manner. For example, the first model is deployed on the second device in a file encryption manner. Further, the first device may also deploy the first model on the second device in a manner of combination of dynamic protection and encryption. For example, the first model may be a model obfuscated by the model, and then deployed on the second device in an encrypted manner. In a process in which the first model runs on the second device, the second device cannot understand logic of the first model, which helps prevent the first model deployed at the second device from being stolen during operation.

The first information may be transmitted for multiple times, and a time interval between two consecutive times of transmission of the first information may be determined based on a first time interval. Further, the first time interval may be a minimum time interval between two consecutive times of transmission of the first information, that is, a time interval between two consecutive times of transmission of the first information is not less than the first time interval. Then, the first device may limit a transmission frequency of the first information based on the first time interval, thereby limiting a frequency of querying the first model by the second device, which helps improve difficulty of model theft and reduce air interface resource overheads caused by model theft. Further, the first information may be periodic, that is, the time interval between two consecutive times of transmission of the first information may be fixed. Certainly, the first information may also be aperiodic, which is not limited in this application.

The first time interval may be determined based on one or more of the following: configuration information of a first service, where the first service may be a service executed by the first model; a quantity of times the second device is allowed to transmit the query request based on the first information.

A size of the first time interval may be related to configuration information of the first service, and the configuration information of the first service may be determined based on a requirement of the first service. First services with different requirements may use first time intervals of different sizes, which helps meet a service requirement. As an example, the first service may be a beam prediction service. Configuration of the first time interval may be shown in Table 1, and may be configured according to whether the beam indication manner is a dynamic indication or a semi-static indication. In another example, the first service may also be a positioning service. The configuration of the first time interval may be shown in Table 2, and a relatively short configuration is configured for the periodic positioning request service. However, in a case in which a service requirement is met, a relatively long time interval is configured for the aperiodic positioning request service.

TABLE 1

| | | |
|---|---|---|
| Service | For dynamic | For semi-static |
| requirements | indication | indication |
| First time | 1 slot | 10 slots |
| interval | | |

TABLE 2

| | | |
|---|---|---|
| Service | For periodical | For aperiodic |
| requirements | positioning | positioning |
| | service request | service request |
| First time | 1 s | 100 s |
| interval | | |

The size of the first time interval may also be related to a quantity of times the second device is allowed to transmit the query request, and the quantity of times the second device is allowed to transmit the query request may be determined based on the first information. The larger quantity of times the second device is allowed to transmit the query request, the larger the first time interval can be appropriately configured. In this way, a transmission frequency of the first information can be adapted to a quantity of times allowed for query the first model, thereby further limiting a frequency of querying the first model by the second device.

The first information may also include a first bit, and a value of the first bit may include a first value and/or a second value. The first value may be used to authorize the second device to transmit the query request, and the second value may be used to prohibit the second device from transmitting the query request, that is, the first bit may be used to indicate whether the first device authorizes the second device to transmit the query request. Before transmitting the first information to the second device, the first device may first determine whether to provide the query service of the first model for the second device, so as to determine a value of the first bit. The first device may determine, according to a previous preparation procedure, whether to provide a query service of the first model for the second device. The previous preparation procedure may include a signaling procedure such as capability reporting, which is not specifically limited in this application. When the first device determines to provide the query service of the first model for the second device, the value of the first bit may be set to the first value. Otherwise, when the first device determines that the query service of the first model is not provided for the second device, the value of the first bit may be set to the second value. For example, when the first device considers that the second device is likely to steal a model, the first device may set a value of the first bit to a second value, so as to prevent the second device from transmitting a query request. For example, the first device may record, by using the blacklist, the identifier of the second device that has a history of malicious query. When discovering that the identifier of the second device is on the blacklist, the first device forbids the first device to transmit the query request by setting a value of the first bit to a second value. Based on the first bit, the first device and the second device may effectively determine whether the second device is allowed to query the first model, thereby helping to improve confidentiality of the first model.

Further, the first device may determine, according to a value of the first bit, whether to respond to the query request transmitted by the second device. As an example, the method shown in FIG. 7 may further include step S720 and step S730. In step S720, the first device receives the query request transmitted by the second device. In step S730, if the value of the first bit recorded by the first device is the first value, the first device transmits a query result corresponding to the query request to the second device; and/or, if the value of the first bit recorded by the first device is the second value, the first device does not respond to the query request. That is, the first device may not respond to a query request of an unauthorized second device, thereby helping to further prevent model theft. The query result herein may be a direct result or an indirect result obtained from inference by the first model, the direct result is a result that is directly output from inference by the first model, and the indirect result is a result obtained by processing the direct result.

Further, after the first device transmits the query result to the second device, the first device may set the value of the first bit to the second value. When the first device acknowledges that the query service of the first model may be provided for the second device again, the first device sets the value of the first bit to the first value. Alternatively, when the first device receives the query request of the first device again, the first device does not respond to the query request. By recording and managing the first bit by the first device, a limitation of the first device on querying the first model by the second device can be strengthened, thereby helping to further improve confidentiality of the first model.

The first information may be transmitted by using a control channel, and the first information may be carried in control channel information or control information. For example, the first information may be carried in DCI or physical downlink control channel (PDCCH) information. For another example, the first information may also be carried in uplink control information (UCI) or physical uplink control channel (PUCCH) information.

Further, the quantity of bits occupied by the first information may be determined according to content included in the first information. For example, the first information includes a first bit, but does not include the quantity of times that a query request is allowed to be transmitted and decryption information of the first model. As shown in FIG. 8A or FIG. 8B, one bit may be added to the original DCI/PDCCH or UCI/PUCCH information to carry the first information. For another example, the first information includes decryption information of the first model, but does not include the quantity of times that a query request is allowed to be transmitted and a first bit. As shown in FIG. 8C or FIG. 8D, the k bit may be added to the original DCI/PDCCH or UCI/PUCCH information to carry the first information, and the k value may be flexibly configured according to a length of the encrypted information.

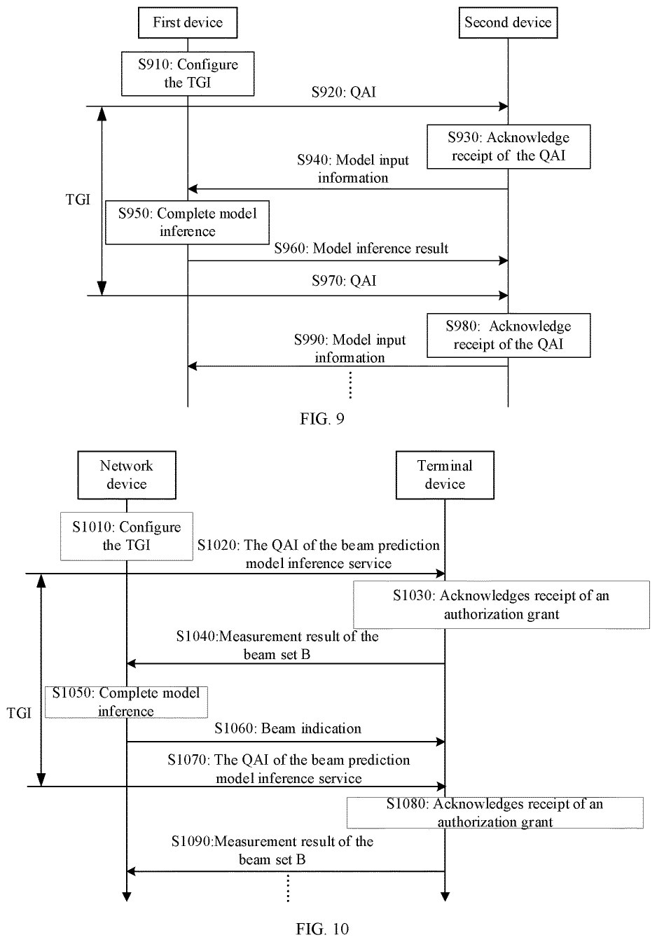

With reference to FIG. 9, the following provides an example of a wireless communication method according to an embodiment of this application. As an example, the first information may be query authorization indication (QAI) information, and the first time interval may be a time guard interval (TGI). In addition, the QAI may also be referred to as a query authorization indication of model inference.

The method shown in FIG. 9 may include steps S910-S990, where the first device is an owner of the first model and the second device is a querier of the second model. The first model may be configured to execute a service, and the first model is deployed on a first device side.

In step S910, the first device configures the TGI. The first device may configure the TGI according to a service requirement, so as to determine a transmission time of the QAI.

In step S920, the first device transmits the QAI to the second device. After completing the previous preparation procedure, the first device may confirm that a model inference query service is provided for the second device. Therefore, the first device may transmit the QAI to the second device, so as to authorize the second device to transmit the query request.

In step S930, the second device acknowledges receipt of the QAI. When acknowledging that the authorization grant of the first device is received, the second device may initiate a query request to the first device.

In step S940, the second device transmits the model input information to the first device. The second device may initiate the model query request in a manner of transmitting the model input information to the first device.

In step S950, the first device completes model inference. The first device may input the model input information into the first model, perform model inference, and obtain a model inference result.

In step S960, the first device transmits the model inference result to the second device. The first device may transmit a direct result of the model inference, or may transmit an indirect result of the model inference.

At this point, a complete process from the model query request to the execution of the model inference is completed between the two devices. In the method shown in FIG. 9, the QAI may be configured by default to allow only one query request in the future. Therefore, based on one transmission of the QAI, steps S940-S960 may be performed once. Certainly, the QAI may also be configured to permit a limited quantity of queries. In that case, based on one transmission of the QAI, steps S940-S960 may be executed for a limited quantity of times, but cannot exceed the quantity of times permitted by the QAI.

As described above, the TGI may be configured to determine transmission time of the QAI, and therefore, the first device may start timing from step S920. After the TGI configured in the S910 is performed, as shown in step S970, the first device may transmit the QAI to the second device again, so as to limit a model query request in a future period (a time span specified by one TGI). Subsequent steps may be cyclically performed the above process from the query request to the inference execution, and details are not described herein again.

As described above, the first model may be configured to execute a service in a wireless communication system. For ease of understanding, the following separately describes, by using different service scenarios as examples, the wireless communication methods provided in the embodiments of this application with reference to Embodiment 1 to Embodiment 4. Embodiment 1 and Embodiment 2 take the first model performing a beam prediction service as an example. Embodiment 3 and Embodiment 4 take the first model performing a positioning service as an example. Exemplarily, in the following embodiments, the first information may be QAI, and the first time interval may be TGI.

### Embodiment 1

In Embodiment 1, a beam prediction model (first model) trained by a network device (first device) provides a query service for the terminal device (second device). The beam prediction model is deployed on the network device, and the terminal device queries the beam prediction model by transmitting a query request to the network device. Based on this, the method provided in this application may be shown in FIG. 10, and includes steps S1010-S1090.

In step S1010, the network device configures the TGI. In this embodiment, the network device configures TGI based on the beam prediction service configuration information. Based on the configuration information, a beam indication manner of the beam prediction service is a dynamic indication. Therefore, the TGI configured by the network device is relatively short, being 1 slot.

In step S1020, the network device transmits the QAI of the beam prediction model inference service to the terminal device. If the QAI includes the first bit, the quantity of bits occupied by the QAI may be shown in FIG. 8A or FIG. 8B. The network device determines that a query service of the beam prediction model is provided for the terminal device, and a value of the first bit may be 1 (indicating that a query request of the UE is allowed to be performed once in the future).

In step S1030, the terminal device acknowledges receipt of an authorization grant from the network device. Based on the first bit in the QAI, the terminal device may confirm that the authorization grant of the network device is obtained, and then the terminal device may initiate a query request to the network device.

In step S1040, the terminal device reports a measurement result of the beam set B to the network device. A measurement result of the beam set B may be used as input information of the beam prediction model.

In step S1050, the network device completes model inference. After receiving the measurement result of the beam set B transmitted by the terminal device, the network device checks the value of the first bit in the QAI corresponding to the terminal device. If the value of the first bit is 0, the network device does not perform any inference-related operation. If the value of the first bit is 1, the network device may input the measurement result of the beam set B into the beam prediction model to obtain the inference result, and further process the inference result into a beam indication.

In step S1060, the network device transmits a beam indication to the terminal device. Subsequently, the network device may modify the value of the first bit to 0 (indicating that the UE is prohibited from initiating a query request). In this case, the terminal device completes one query of the beam prediction model.

In addition, the network device starts timing from step S1020. After the time interval (1 slot) configured by the TGI is elapsed, the network device may set a value of the first bit to 1. In addition, as shown in step S1070, the network device may transmit the QAI to the terminal device again, so as to authorize the terminal device to query the beam prediction model. Subsequent steps may be cyclically performed from the query request to the inference execution process, and details are not described herein again.

Based on the method shown in FIG. 10, the frequency at which the terminal device queries the beam prediction model deployed in a network device is limited by the network device, so as to prevent the terminal device from performing model stealing through multiple times of queries in a short time. At the same time, when the terminal device encounters a malicious query attack, a huge air interface resource waste caused by reporting a large quantity of input information may be avoided.

### Embodiment 2

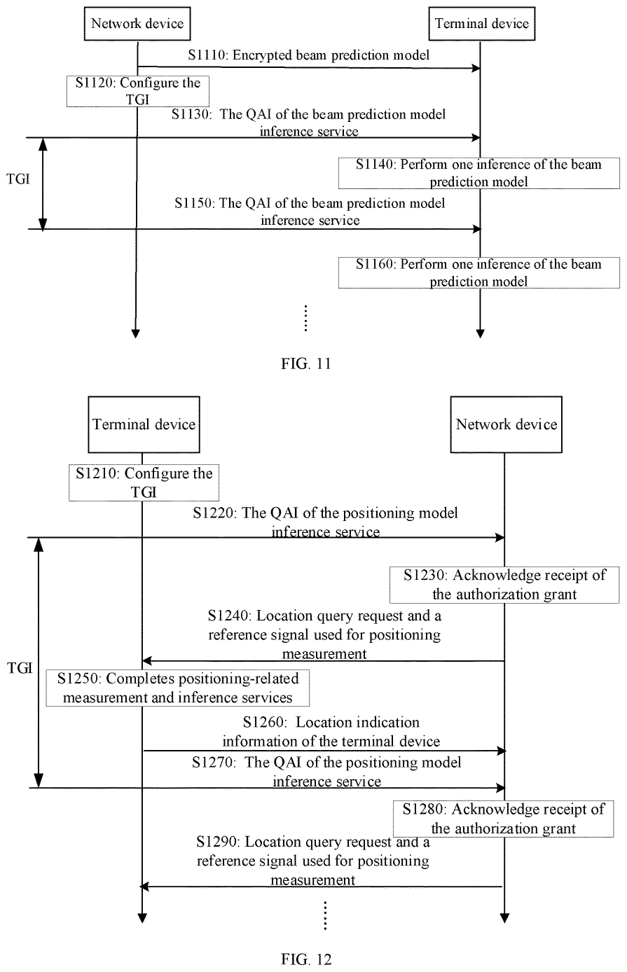

In Embodiment 2, a network device (first device) trains a beam prediction model (first model) to provide a query service for the terminal device (second device). The network device deploys the obfuscated beam prediction model to the terminal device in a file encryption manner, and the terminal device queries the beam prediction model by transmitting a query request to its local side. Based on this, the method provided in this application may be shown in FIG. 11, and includes steps S1110-S1160.

In step S1110, the network device transmits the encrypted beam prediction model to the terminal device. When the terminal device queries the beam prediction model locally, the terminal device needs to decrypt the model by using a key generated by the network device.

In step S1120, the network device configures the TGI. In this embodiment, the network device configures TGI based on configuration information of the beam prediction service. Based on the configuration information, the beam indication manner of the beam prediction service is a semi-static indication. Therefore, the TGI configured by the network device is long, being 10 slots.

In step S1130, the network device transmits the QAI of the beam prediction model inference service to the terminal device. The QAI may be used to indicate a quantity of times of querying a model by the terminal device, and carry key information of the model. Therefore, the quantity of bits occupied by the QAI may be shown in FIG. 8C or FIG. 8D.

In step S1140, the terminal device performs one inference of the beam prediction model. The terminal device may confirm receipt of authorization grant from the network device based on the key information in the QAI. The terminal device may decrypt the model file by using the key information, and input a beam measurement result into the model to obtain an inference result. The terminal device may further process the inference result into beam indication information, so as to guide beam switching. After one inference is completed, the beam prediction model is automatically encrypted, and cannot perform inference again to provide correct query results.

In addition, the network device starts timing from step S1120. After a time interval (10 slots) configured by the TGI is elapsed, as shown in step S1150, the network device may transmit, to the terminal device, the QAI that carries the latest key information again. Subsequent steps may be cyclically performed from the query request to the inference execution process, and details are not described herein again.

Based on the method shown in FIG. 11, the frequency at which the terminal device queries the beam prediction model deployed locally is limited by the network device, which helps prevent the terminal device from performing model stealing on the model deployed locally.

### Embodiment 3

In Embodiment 3, a positioning model (first model) trained by a terminal device (first device) provides a query service for the network device (second device). The positioning model is deployed on the terminal device, and the network device queries the positioning model by transmitting a query request to the terminal device. Based on this, the method provided in this application may be shown in FIG. 12, and includes steps S1210-S1290.

In step S1210, the terminal device configures the TGI. In this embodiment, the terminal device configures the TGI based on the configuration information of the positioning service. Based on the configuration information, the positioning service is used for a periodic positioning service request. Therefore, the TGI configured by the terminal device is relatively short, which is 1 s.

In step S1220, the terminal device transmits the QAI of the positioning model inference service to the network device. If the QAI includes the first bit, a quantity of bits occupied by the QAI may be shown in FIG. 8A or FIG. 8B. The terminal device determines that a positioning model query service is provided for the network device, and a value of the first bit may be 1 (indicating that the query request from the UE is allowed to be performed once in the future).

In step S1230, the network device acknowledges receipt of the authorization grant from the terminal device. Based on the first bit in the QAI, the network device may confirm that the authorization grant of the terminal device is obtained, and the network device may initiate a query request to the terminal device.

In step S1240, the network device transmits a location query request and a reference signal used for positioning measurement to the terminal device.

In step S1250, the terminal device completes positioning-related measurement and inference services. After receiving the positioning request transmitted by the network device, the terminal device checks the value of the first bit in the QAI corresponding to the network device. If the value of the first bit is 0, the terminal device does not perform any inference-related operation. If the value of the first bit is 1, the terminal device may process the positioning measured reference signal to obtain the measurement information, and input the measurement information into the positioning model to obtain the location information, so as to further process the location information into location indication information or the location-related control information.

In step S1260, the terminal device transmits location indication information of the terminal device to the network device. Then, the terminal device may modify the value of the first bit to 0 (indicating that the UE is prohibited from initiating a query request). In this case, the network device completes one query of the positioning model.

In addition, the terminal device starts timing from step S1220. After the time interval (1s) configured by the TGI is elapsed, the terminal device may set the value of the first bit to 1. In addition, as shown in step S1270, the terminal device may transmit the QAI of the positioning model inference service to the network device again, so as to authorize the network device to query the positioning model. Subsequent steps may be cyclically performed from the query request to the inference execution process, and details are not described herein again.

Based on the method shown in FIG. 12, the frequency at which the network device queries positioning model deployed on a terminal device is limited by the terminal device, which helps prevent the network device from performing model theft through multiple times of queries in a short time. In addition, when the network device encounters a malicious query attack, a huge air interface resource waste caused by reporting a large quantity of input information may be avoided.

### Embodiment 4

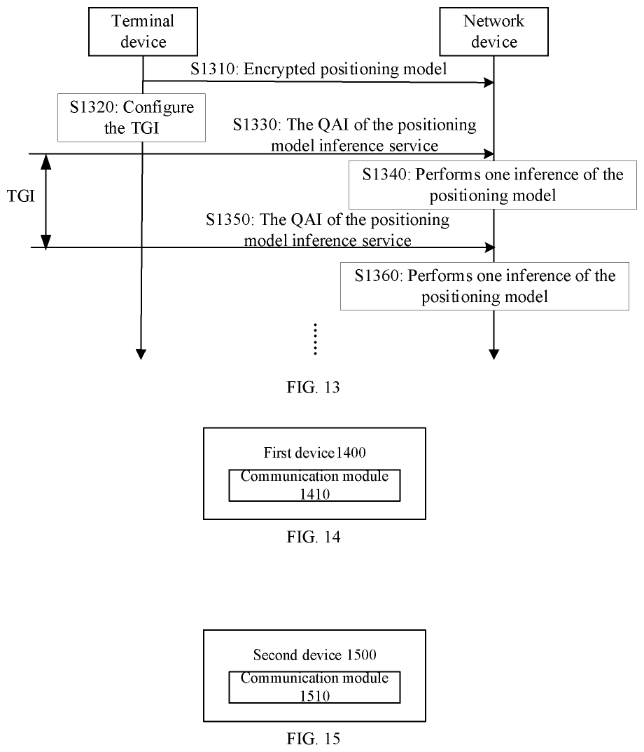

In Embodiment 4, a positioning model (first model) trained by a terminal device (first device) provides a query service for a network device (second device). The terminal device deploys the obfuscated positioning model to the network device in a file encryption manner, and the network device queries the positioning model by transmitting a query request to the terminal device locally. Based on this, the method provided in this application may be shown in FIG. 13, and includes steps S1310-S1360.

In step S1310, the terminal device transmits an encrypted positioning model to the network device. When the network device locally queries the positioning model, the network device needs to decrypt the model by using a key generated by the terminal device.

In step S1320, the terminal device configures the TGI. In this embodiment, the terminal device configures the TGI based on the configuration information of the positioning service. Based on the configuration information, the positioning service is used for an aperiodic positioning request service. Therefore, the TGI configured by the terminal device is relatively long, being 100 s.

In step S1330, the terminal device transmits the QAI for the positioning model inference service to the network device. The QAI may be used to indicate a quantity of times of querying a model by the network device, and carry key information of the model. Therefore, a quantity of bits occupied by the QAI may be as shown in FIG. 8C or FIG. 8D.

In step S1340, the network device performs one inference of the positioning model. The network device may confirm, based on the key information in the QAI, that the authorization grant of the terminal device is received. The network device may decrypt the model file by using the key information to complete one model inference. After one inference, the location model is encrypted automatically, and cannot perform inference again to provide correct query results.

In addition, after the QAI is transmitted, the terminal device starts timing. After a time interval (100s) configured by the TGI is elapsed, as shown in step S1350, the terminal device may transmit the QAI for the positioning model inference service to the network device again, so as to authorize the network device to query the positioning model.

Based on the method shown in FIG. 13, a frequency at which the network device queries the positioning model deployed locally is limited by a terminal device, which helps prevent the network device from stealing a model deployed locally.

The foregoing describes the method embodiments of this application in detail. The following describes apparatus embodiments of this application in detail. It should be understood that the descriptions of the method embodiments correspond to descriptions of the apparatus embodiments, and therefore, for parts that are not described in detail, reference may be made to the foregoing method embodiments.

FIG. 14 is a schematic structural diagram of a first device according to an embodiment of this application. The first device 1400 in FIG. 14 includes a communication module 1410. The communication module 1410 may be configured to transmit first information to the second device, and the first information may be used to authorize the second device to transmit a query request for the first model.

In some implementations, the first information may include one or more of the following information: a quantity of times allowed for transmitting the query request; decryption information of the first model.

In some implementations, when the first model is deployed on the second device, the first information may include decryption information.

In some implementations, a time interval between two consecutive times of transmission of the first information may be determined based on a first time interval.

In some implementations, the first time interval may be a minimum time interval for two consecutive times of transmission of the first information.

In some implementations, the first time interval may be determined based on one or more of the following: configuration information of the first service, where the first service is a service executed by the first model; and

a quantity of times the second device is allowed to transmit the query request based on the first information.

In some implementations, the first information may include a first bit, a value of the first bit may include a first value and/or a second value, the first value may be used to authorize the second device to transmit a query request, and the second value may be used to prohibit the second device from transmitting the query request.

In some implementations, the communication module 1410 may be further configured to receive the query request transmitted by the second device. If a value of the first bit recorded by the first device is the first value, transmitting a query result corresponding to the query request to the second device; and if the value of the first bit recorded by the first device is the second value, the first device skips responding to the query request.

In some implementations, the first device 1400 may further include a setting module 1420. The setting module 1420 may be configured to set the value of the first bit to the second value after the communication module 1410 transmits the query result to the second device.

In some implementation manners, the first model may be deployed at the first device. Alternatively, the first model may be deployed on the second device.

In some implementations, the first model may be configured to perform a beam prediction service or a positioning service.

In some implementations, the first device may be an owner of the first model, and the second device may be a user of the first model.

FIG. 15 is a schematic structural diagram of a second device according to an embodiment of this application. The second device 1500 in FIG. 15 includes a communication module 1510. The communication module 1510 may be configured to receive first information transmitted by a first device, and the first information may be used to authorize the second device to transmit a query request for a first model.

In some implementations, the first information may include one or more of the following information: a quantity of times allowed for transmitting the query request; decryption information of the first model.

In some implementations, when the first model is deployed on the second device, the first information may include decryption information.

In some implementation manners, a time interval between two consecutive times of transmission of the first information may be determined based on a first time interval.

In some implementation manners, the first time interval may be a minimum time interval for two consecutive times of transmission of the first information.

In some implementation manners, the first time interval may be determined based on one or more of the following: configuration information of a first service, where the first service is a service executed by the first model; and a quantity of times the second device is allowed to transmit the query request based on the first information.

In some implementations, the first information may include a first bit, a value of the first bit may include a first value and/or a second value, the first value may be used to authorize the second device to transmit the query request, and the second value may be used to prohibit the second device from transmitting a query request.

In some implementation manners, the first model may be deployed at the first device. Alternatively, the first model may be deployed on the second device.

In some implementations, the first model may be configured to perform a beam prediction service or a positioning service.

In some implementations, the first device may be an owner of the first model, and the second device may be a user of the first model.

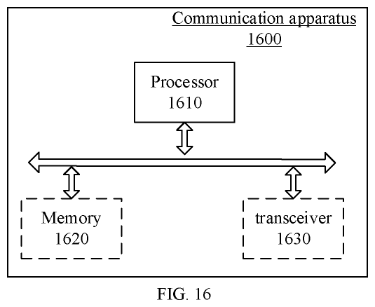

FIG. 16 is a schematic structural diagram of a communication apparatus according to an embodiment of this application. The communication apparatus 1600 in FIG. 16 may be configured to implement the method described in the foregoing method embodiments. The apparatus 1600 may be a chip, a terminal device, or a base station.

The communication apparatus 1600 may include one or more processors 1610. The processor 1610 may support the apparatus 1600 in implementing the methods described in the foregoing method embodiments. The processor 1610 may be a general-purpose processor or a dedicated processor. For example, the processor may be a central processing unit (CPU). Alternatively, the processor may be another general-purpose processor, a digital signal processor (DSP), an application-specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

The communication apparatus 1600 may further include one or more memories 1620. The memory 1620 stores a program, and the program may be executed by the processor 1610, so that the processor 1610 executes the method described in the foregoing method embodiments. The memory 1620 may be separate from the processor 1610 or may be integrated into the processor 1610.

The communication apparatus 1600 may further include a transceiver 1630. The processor 1610 may communicate with another device or chip by using the transceiver 1630. For example, the processor 1610 may perform data transceiver with another device or chip by using the transceiver 1630.

It should be understood that in this embodiment of this application, the processor 1610 may use a general-purpose central processing unit (CPU), a microprocessor, an application specific integrated circuit (ASIC), or one or more integrated circuits to execute a related program, so as to implement the technical solution provided in this embodiment of this application.

The memory 1620 may include a read-only memory and a random access memory, and provides an instruction and data for the processor 1610. A part of the processor 1610 may further include a non-volatile random access memory. For example, the processor 1610 may further store information about a device type.

In an implementation process, steps in the foregoing methods can be implemented by using a hardware integrated logical circuit in the processor 1610, or by using instructions in a form of software. The method for requesting an uplink transmission resource disclosed with reference to the embodiments of this application may be directly executed by a hardware processor, or executed by a combination of hardware and software modules in the processor. The software module may be located in a mature storage medium in the art such as a random access memory, a flash memory, a read-only memory, a programmable read-only memory, or an electrically erasable programmable memory and a register. The storage medium is located in the memory 1620. The processor 1610 reads information in the memory 1620 and completes the steps of the foregoing methods with reference to hardware of the processor 1610. To avoid repetition, details are not described herein again.

It should be understood that, in this embodiment of this application, the processor 1610 may be a central processing unit (CPU), and the processor may be another general purpose processor, a digital signal processor (DSP), an application specific integrated circuit (ASIC), a field programmable gate array (FPGA) or another programmable logic device, a discrete gate or transistor logic device, a discrete hardware component, or the like. The general-purpose processor may be a microprocessor, or the processor may be any conventional processor or the like.

An embodiment of this application further provides a computer-readable storage medium, configured to store a program. The computer readable storage medium may be applied to the first device or the second device provided in the embodiments of this application, and the program causes the computer to execute the wireless communication method in the embodiments of this application.

An embodiment of this application further provides a computer program product. The computer program product includes a program. The computer program product may be applied to the first device or the second device provided in the embodiments of this application, and the program causes the computer to execute the wireless communication method in the embodiments of this application.

An embodiment of this application further provides a computer program. The computer program may be applied to the first device or the second device provided in the embodiments of this application, and the computer program causes the computer to execute the wireless communication method in the embodiments of this application.

It should be understood that all or some of functions of the communication device in this application may alternatively be implemented by software functions running on hardware, or by virtualization functions instantiated on a platform (for example, a cloud platform).

It should be understood that the terms “system” and “network” in this application may be used interchangeably. In addition, the terms used in this application are used only to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

In embodiments of this application, “indication” mentioned herein may refer to a direct indication, or may refer to an indirect indication, or may mean that there is an association relationship. For example, if A indicates B, it may mean that A directly indicates B, for example, B may be obtained from A. Alternatively, it may mean that A indicates B indirectly, for example, A indicates C, and B may be obtained from C. Alternatively, it may mean that there is an association relationship between A and B.

In embodiments of this application, “B corresponding to A” means that B is associated with A, and B may be determined based on A. However, it should be further understood that, determining B based on A does not mean determining B based only on A, but instead, B may be determined based on A and/or other information.

In embodiments of this application, the term “correspond” may mean that there is a direct or indirect correspondence between the two, or may mean that there is an association relationship between the two, or may mean that there is a relationship such as indicating and being indicated, or configuring and being configured.

In embodiments of this application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of this application, the “include” may refer to direct inclusion, or may refer to indirect inclusion. Optionally, the term “include” mentioned in embodiments of this application may be replaced with “indicate” or “be used to determine”. For example, A including B may be replaced with that A indicates B, or A is used to determine B.

In embodiments of this application, sequence numbers of the foregoing processes do not mean execution orders. The execution orders of the processes should be determined based on functions and internal logic of the processes, and should not be construed as any limitation on the implementation processes of embodiments of this application.

In several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual needs to achieve the objective of the solutions of embodiments.

In addition, functional units in embodiments of this application may be integrated into one processing unit, or each of the units may exist alone physically, or two or more units may be integrated into one unit.

When software is used to implement the embodiments, all or a part of the embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
transmitting, by a first device, first information to a second device, wherein the first information is used to authorize the second device to transmit a query request for a first model.

2. The method according to claim 1, wherein the first information comprises one or more of following information:
a quantity of times allowed to transmit the query request;
decryption information of the first model.

3. The method according to claim 2, wherein in a case that the first model is deployed on the second device, the first information comprises the decryption information.

4. The method according to claim 1, wherein a time interval between two consecutive times of transmission of the first information is determined based on a first time interval.

5. The method according to claim 4, wherein the first time interval is a minimum time interval for two consecutive times of transmission of the first information.

6. The method according to claim 4, wherein the first time interval is determined based on one or more of the following:
configuration information of a first service, wherein the first service is a service executed by the first model; and
a quantity of times that the second device is allowed to transmit the query request based on the first information.

7. The method according to claim 1, wherein the first information comprises a first bit, a value of the first bit comprises a first value and/or a second value, the first value is used to authorize the second device to transmit the query request, and the second value is used to prohibit the second device from transmitting the query request.

8. The method according to claim 7, wherein the method further comprises:
receiving, by the first device, the query request transmitted by the second device; and
in a case that the value of the first bit recorded by the first device is the first value, transmitting, by the first device, a query result corresponding to the query request to the second device; and/or
in a case that the value of the first bit recorded by the first device is the second value, the first device skips responding to the query request.

9. The method according to claim 8, wherein the method further comprises:
setting, by the first device, the value of the first bit to the second value after the first device transmits the query result to the second device.

10. The method according to claim 1, wherein the first model is deployed on the first device;
or the first model is deployed on the second device.

11. The method according to claim 1, wherein the first model is configured to perform a beam prediction service or a positioning service.

12. The method according to claim 1, wherein the first device is an owner of the first model, and the second device is a user of the first model.

13. A communication device, wherein the communication device is a first device, and comprises a memory, a processor, and a transceiver, the memory is configured to store a program, the processor is configured to invoke a program in the memory, the transceiver is configured to transmit first information to a second device, and the first information is used to authorize the second device to transmit a query request for a first model.

14. A communication device, wherein the communication device is a second device, and comprises a memory, a processor, and a transceiver, the memory is configured to store a program, the processor is configured to invoke a program in the memory, the transceiver is configured to receive first information transmitted by a first device, and the first information is used to authorize the second device to transmit a query request for a first model.

15. The communication device according to claim 14, wherein the first information comprises one or more of the following information:
a quantity of times allowed to transmit the query request;
decryption information of the first model.

16. The communication device according to claim 15, wherein in a case that the first model is deployed on the second device, the first information comprises the decryption information.

17. The communication device according to claim 14, wherein a time interval between two consecutive times of transmission of the first information is determined based on a first time interval.

18. The communication device according to claim 17, wherein the first time interval is a minimum time interval for two consecutive times of transmission of the first information.

19. The communication device according to claim 17, wherein the first time interval is determined based on one or more of the following:
configuration information of a first service, wherein the first service is a service executed by the first model; and
a quantity of times that the second device is allowed to transmit the query request based on the first information.

20. The communication device according to claim 14, wherein the first information comprises a first bit, a value of the first bit comprises a first value and/or a second value, the first value is used to authorize the second device to transmit the query request, and the second value is used to prohibit the second device from transmitting the query request.
